(19) United States
(12) Patent Application Publication
(10) Pub. No.: US 2023/0140287 A1
(43) Pub. Date: May 4, 2023

(54) GUARD INTERVAL COMMUNICATIONS

(71) Applicant: QUALCOMM Incorporated, San Diego, CA (US)

(72) Inventors: Iyab Issam SAKHNINI, San Diego, CA (US); Tao LUO, San Diego, CA (US); Xiaoxia ZHANG, San Diego, CA (US); Jing SUN, San Diego, CA (US); Jun MA, San Diego, CA (US); Junyi LI, Fairless Hills, PA (US); Peter GAAL, San Diego, CA (US)

(21) Appl. No.: 17/452,628

(22) Filed: Oct. 28, 2021

(51) Int. Cl. H04W 72/12; H04L 5/00; H04W 72/04

(52) U.S. Cl. CPC H04W 72/1289; H04L 5/0051; H04W 72/048; H04W 72/0446

(57) ABSTRACT

Various aspects of the present disclosure generally relate to wireless communication. In some aspects, a user equipment (UE) may receive, from a base station, a wireless communication, the wireless communication including one or more guard intervals. The UE may identify, based on one or more guard interval characteristics of the one or more guard intervals, control information for the UE. Numerous other aspects are described.

### FIELD OF THE DISCLOSURE

Aspects of the present disclosure generally relate to wireless communication and to techniques and apparatuses for guard interval communications.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving, from a base station, a wireless communication, the wireless communication including one or more guard intervals. The method may include identifying, based on one or more guard interval characteristics of the one or more guard intervals, control information for the UE.

Some aspects described herein relate to a method of wireless communication performed by a base station. The method may include mapping control information, for a UE, to one or more guard interval characteristics of one or more guard intervals. The method may include transmitting, to the UE, a wireless communication, the wireless communication including the one or more guard intervals.

Some aspects described herein relate to a UE for wireless communication. The user equipment may include a memory and one or more processors coupled to the memory. The one or more processors may be configured to receive, from a base station, a wireless communication, the wireless communication including one or more guard intervals. The one or more processors may be configured to identify, based on one or more guard interval characteristics of the one or more guard intervals, control information for the UE.

Some aspects described herein relate to a base station for wireless communication. The base station may include a memory and one or more processors coupled to the memory. The one or more processors may be configured to map control information, for a UE, to one or more guard interval characteristics of one or more guard intervals. The one or more processors may be configured to transmit, to the UE, a wireless communication, the wireless communication including the one or more guard intervals.

Some aspects described herein relate to a non-transitory computer-readable medium that stores a set of instructions for wireless communication by a UE. The set of instructions, when executed by one or more processors of the UE, may cause the UE to receive, from a base station, a wireless communication, the wireless communication including one or more guard intervals. The set of instructions, when executed by one or more processors of the UE, may cause the UE to identify, based on one or more guard interval characteristics of the one or more guard intervals, control information for the UE.

Some aspects described herein relate to a non-transitory computer-readable medium that stores a set of instructions for wireless communication by a base station. The set of instructions, when executed by one or more processors of the base station, may cause the base station to map control information, for a UE, to one or more guard interval characteristics of one or more guard intervals. The set of instructions, when executed by one or more processors of the base station, may cause the base station to transmit, to the UE, a wireless communication, the wireless communication including the one or more guard intervals.

Some aspects described herein relate to an apparatus for wireless communication. The apparatus may include means for receiving, from a base station, a wireless communication, the wireless communication including one or more guard intervals. The apparatus may include means for identifying, based on one or more guard interval characteristics of the one or more guard intervals, control information for the UE.

Some aspects described herein relate to an apparatus for wireless communication. The apparatus may include means for mapping control information, for a UE, to one or more guard interval characteristics of one or more guard intervals. The apparatus may include means for transmitting, to the UE, a wireless communication, the wireless communication including the one or more guard intervals.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of physical channels and reference signals in a wireless network, in accordance with the present disclosure.

FIG. 4 is a diagram illustrating an example of a cyclic prefix (CP) and a guard interval (GI) for single carrier (SC) waveforms, in accordance with the present disclosure.

FIG. 5 is a diagram illustrating an example of guard interval communications, in accordance with the present disclosure.

FIG. 6 is a diagram illustrating an example associated with guard interval communications using time domain indices, in accordance with the present disclosure.

FIG. 7 is a diagram illustrating an example associated with guard interval communications including a demodulation reference signal (DMRS), in accordance with the present disclosure.

FIG. 8 is a diagram illustrating an example associated with guard interval communications on a communication to different devices, in accordance with the present disclosure.

FIGS. 9 and 10 are diagrams illustrating example processes associated with guard interval communications, in accordance with the present disclosure.

FIGS. 11 and 12 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

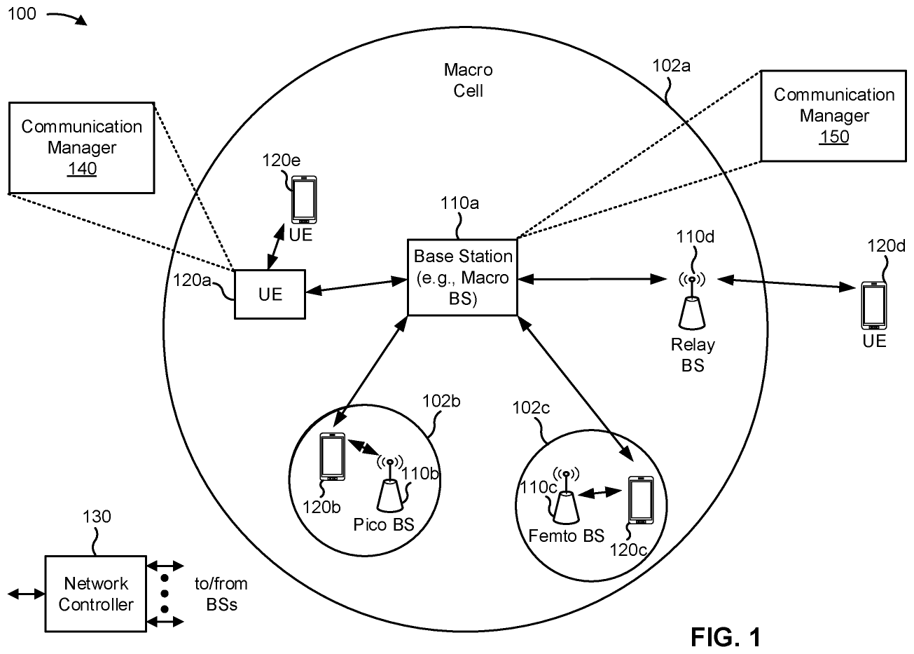

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a base station, a wireless communication, the wireless communication including one or more guard intervals; and identify, based on one or more guard interval characteristics of the one or more guard intervals, control information for the UE. Additionally, or alternatively, the communication manager 140 may perform one or more other operations described herein.

In some aspects, the base station 110 may include a communication manager 150. As described in more detail elsewhere herein, the communication manager 150 may map control information, for a UE, to one or more guard interval characteristics of one or more guard intervals; and transmitting, to the UE, a wireless communication, the wireless communication including the one or more guard intervals. Additionally, or alternatively, the communication manager 150 may perform one or more other operations described herein.

As indicated above, FIG. 1 is provided as an example. Other examples may differ from what is described with regard to FIG. 1.

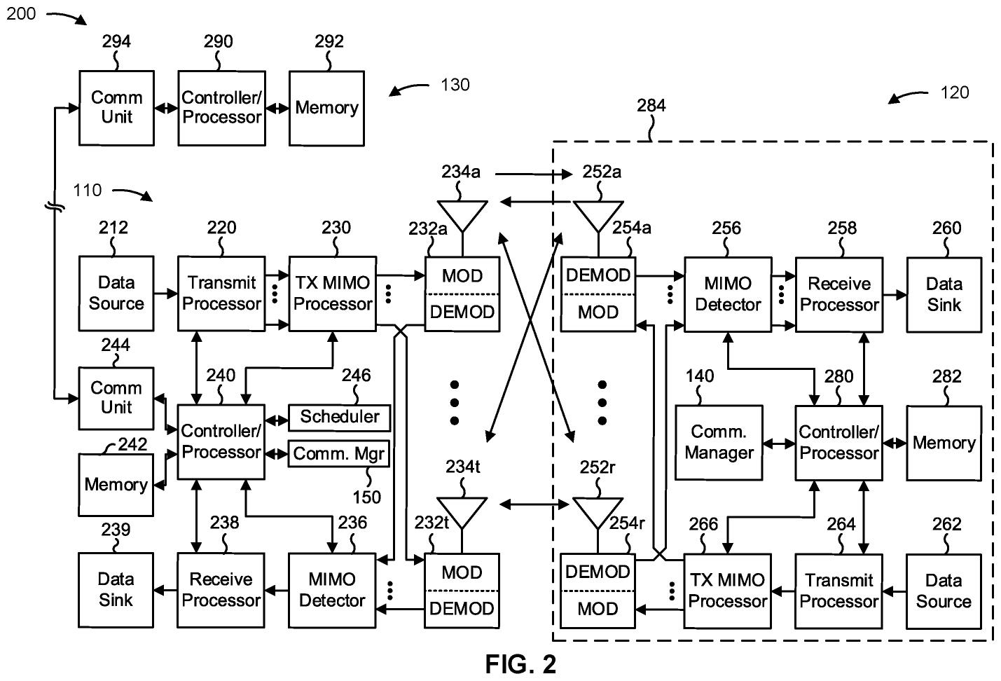

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

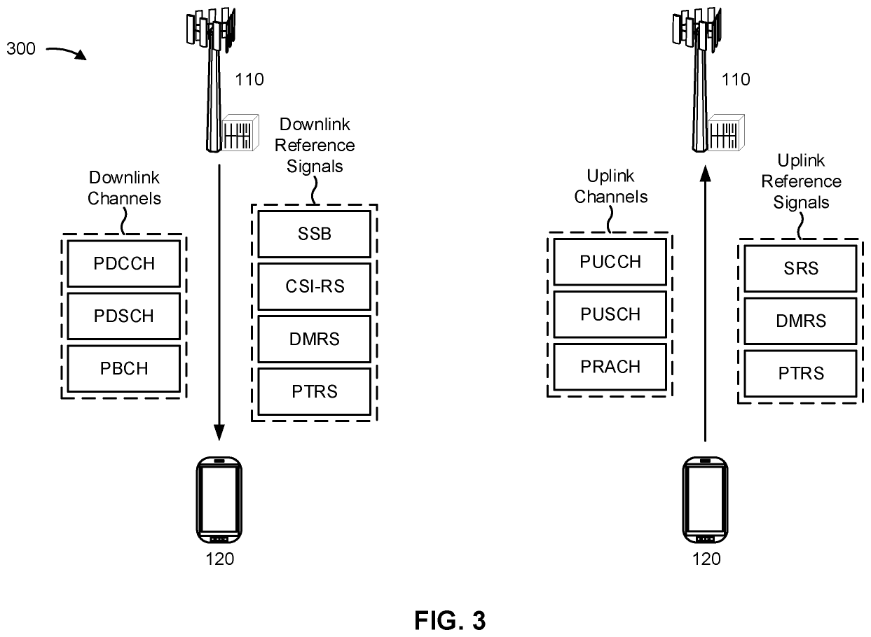

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-12).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-12).

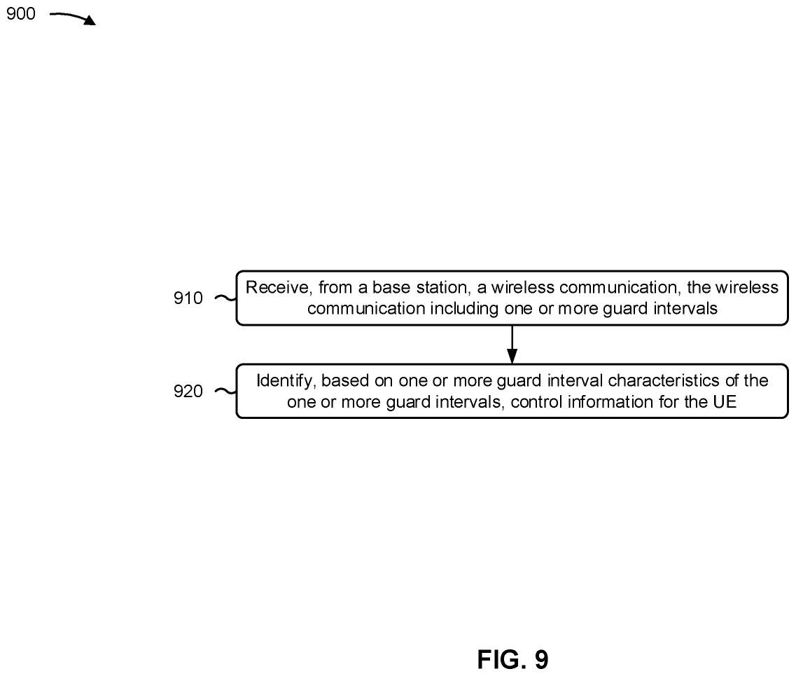

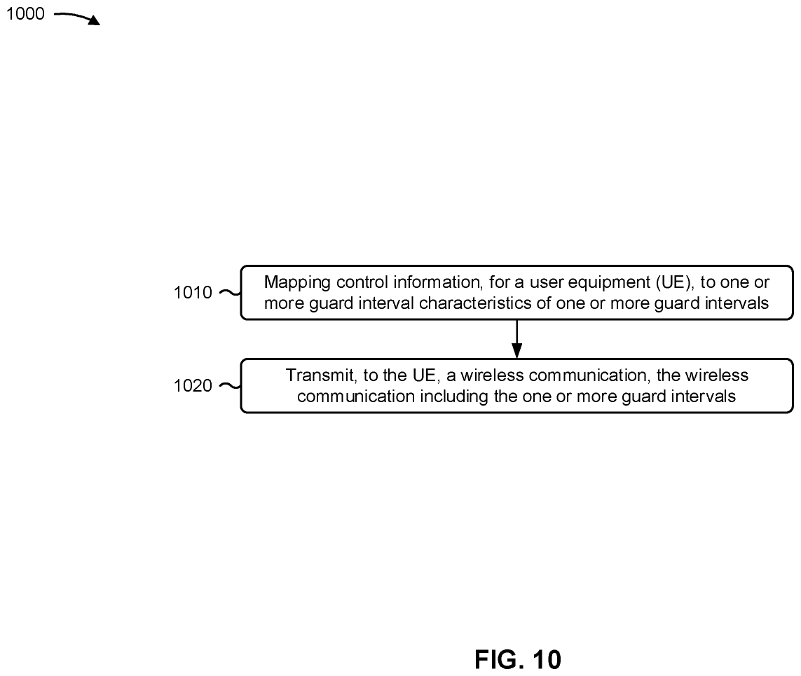

The controller/processor 240 of the base station 110, the controller/processor 280 of the UE 120, and/or any other component(s) of FIG. 2 may perform one or more techniques associated with guard interval communications, as described in more detail elsewhere herein. For example, the controller/processor 240 of the base station 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the UE includes means for receiving, from a base station, a wireless communication, the wireless communication including one or more guard intervals; and/or means for identifying, based on one or more guard interval characteristics of the one or more guard intervals, control information for the UE. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station includes means for mapping control information, for a UE, to one or more guard interval characteristics of one or more guard intervals; and/or transmitting, to the UE, a wireless communication, the wireless communication including the one or more guard intervals. The means for the base station to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

FIG. 3 is a diagram illustrating an example 300 of physical channels and reference signals in a wireless network, in accordance with the present disclosure. As shown in FIG. 3, downlink channels and downlink reference signals may carry information from a base station 110 to a UE 120, and uplink channels and uplink reference signals may carry information from a UE 120 to a base station 110.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a physical random access channel (PRACH) used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

As further shown, a downlink reference signal may include a synchronization signal block (SSB), a channel state information (CSI) reference signal (CSI-RS), a DMRS, a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a PSS, an SSS, a PBCH, and a PBCH DMRS. An SSB is sometimes referred to as a synchronization signal/PBCH (SS/PBCH) block. In some aspects, the base station 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The base station 110 may configure a set of CSI-RSs for the UE 120, and the UE 120 may measure the configured set of CSI-RSs. Based at least in part on the measurements, the UE 120 may perform channel estimation and may report channel estimation parameters to the base station 110 (e.g., in a CSI report), such as a CQI, a precoding matrix indicator (PMI), a CSI-RS resource indicator (CRI), a layer indicator (LI), a rank indicator (RI), or an RSRP, among other examples. The base station 110 may use the CSI report to select transmission parameters for downlink communications to the UE 120, such as a number of transmission layers (e.g., a rank), a precoding matrix (e.g., a precoder), an MCS, or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the base station 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring base stations in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the base station 110 may then calculate a position of the UE 120 based on the RSTD measurements reported by the UE 120.

An SRS may carry information used for uplink channel estimation, which may be used for scheduling, link adaptation, precoder selection, or beam management, among other examples. The base station 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The base station 110 may measure the SRSs, may perform channel estimation based at least in part on the measurements, and may use the SRS measurements to configure communications with the UE 120.

As indicated above, FIG. 3 is provided as an example. Other examples may differ from what is described with regard to FIG. 3.

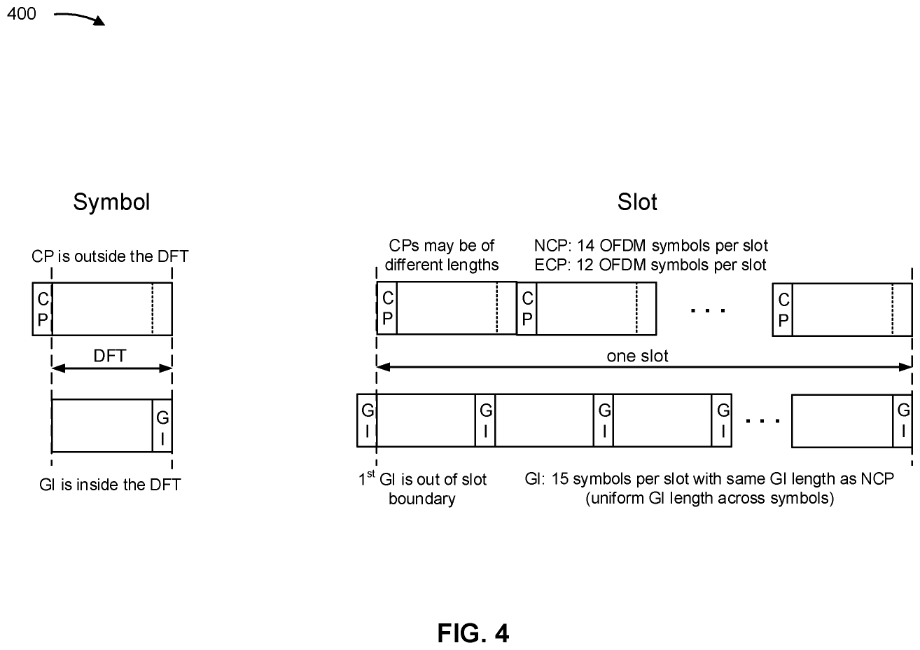

FIG. 4 is a diagram illustrating an example 400 of a cyclic prefix (CP) and a GI for single carrier (SC) waveforms, in accordance with the present disclosure.

A transmitter, such as the UE 120 or the base station 110, may include a short amount of data or space between symbols to mitigate inter-symbol interference (ISI) between adjacent symbols in multipath channel environments. The short amount of data may be a CP, or a prefixing of a symbol, as shown in example 400. The CP may also provide an opportunity for a beam to switch between symbols. The CP may be contained within a slot boundary, may include random data, and may not be easily adaptable to delay spread, which is a difference between arrival of an earliest multi-path component and arrival of a last multi-path component. CPs may be of different lengths. CP is adopted in LTE and NR, and CP is adopted for WiFi OFDM symbols.

The transmitter may also use a GI between symbols. The GI may be a specified period of time between symbols to mitigate interference between the symbols. The GI may be a known sequence that can be utilized for synchronizing phase tracking. For example, the GI of a symbol may be obtained by prepending a copy of the last N data samples from the end of a fast Fourier transform (FFT) block to the beginning of the FFT block. In this way, the symbol structure may result in a circular signal structure, such that the first N data samples and last N data samples of the symbol are identical. In some aspects, the GI may be associated with a particular type of GI, such as a zero tail GI, unique word GI, and/or the like. For example, a zero tail GI may be a GI that includes zeros appended at the end (and in some situations, the beginning) of each symbol. A unique word GI may be a GI that includes a known sequence appended to the end (and in some situations, the beginning) of each symbol. In some aspects, the GI may be of uniform length across symbols. The GI may be more resource efficient than a CP. The GI may adapt to delay spreads without changing a symbol duration. The GI may be adopted for use with WiFi for SC frequency domain equalization (FDE) (SC-FDE).

The transmitter may use signal processing to generate a waveform for data content. The signal processing may involve linear convolution, which is an operation to calculate the output for a linear time invariant system. Linear convolution may use an FFT operation. A CP and a GI may both convert a linear convolution of transmitted symbols to a circular convolution, with a simple one-tap FDE at the receiver. Circular convolution calculates the output for a linear time invariant system but is periodic and utilizes the periodicity of samples in discrete Fourier transform (DFT). A CP and a GI may also help to maintain symbol and slot alignment. A transmitter may use CP and/or GI when transmitted various signals and data using various channels described herein, such as PDCCH, PDSCH, PUCCH, PUSCH, PBCH, and/or the like.

As indicated above, FIG. 4 is provided as an example. Other examples may differ from what is described with regard to FIG. 4.

In a wireless network, transmitters and receivers may transmit and/or receive control information that facilitates wireless communication between devices (e.g., UEs 120 and base stations 110). For example, control information may be communicated using radio resource control (RRC), medium access control (MAC) control elements (MAC-CEs), DCI, UCI, and/or the like. Control information is often carried on the downlink via PDCCH and on the uplink via PUCCH and may be dependent on control resource set (CORESET) resources, SSB periodicity, and/or the like. Utilization of network resources and power resources used to communicate control information may be relatively inefficient in situations where a relatively small amount of control information is being communicated.

Some techniques and apparatuses described herein enable wireless devices to communicate information (e.g., control information) using guard intervals. For example, a first wireless device may transmit a wireless communication to a second wireless device, and the wireless communication may include one or more guard intervals. Upon receipt of the wireless communication, the second wireless device may identify, based on one or more characteristics of the guard interval(s), control information. For example, guard interval characteristics may be mapped to bit values that represent the control information. As a result, wireless devices may communicate control information to one another using less power and network resources than would be used to communicate control information via RRC, MAC-CE, DCI, UCI, and/or the like. Reduced usage of power and network resources may enable wireless devices to conserve power, reduce network congestion, and improve network performance, among other examples.

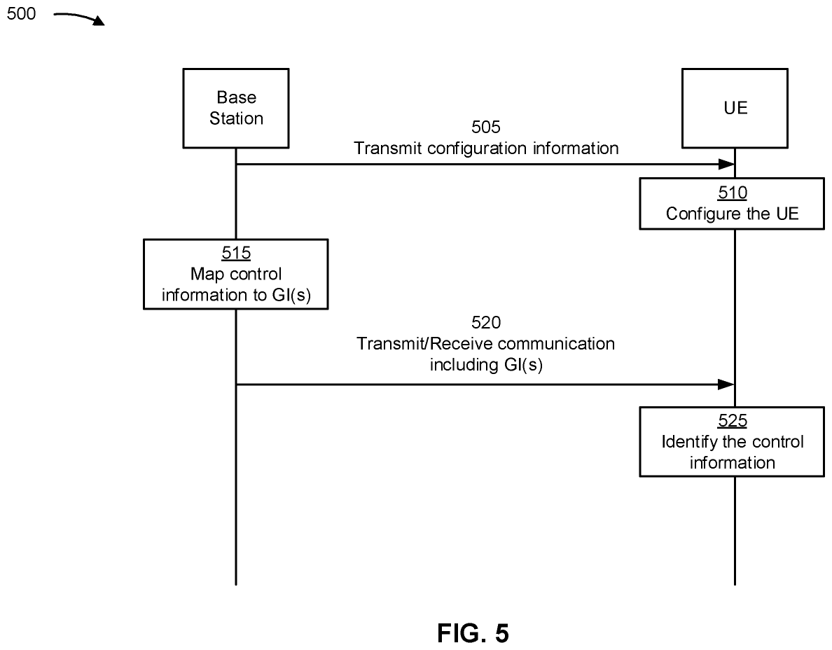

FIG. 5 is a diagram illustrating an example 500 of guard interval communications, in accordance with the present disclosure. As shown in FIG. 5, a UE (e.g., UE 120) may communicate (e.g., transmit an uplink transmission and/or receive a downlink transmission) with a base station (e.g., base station 110). In some aspects, the UE may communicate with another UE via one or more sidelink communications (e.g., in addition to, or in place of, communicating with the base station). The UE and the base station may be part of a wireless network (e.g., wireless network 100).

As shown by reference number 505, the base station may transmit, and the UE may receive, configuration information. In some aspects, the UE may receive configuration information from another device (e.g., from another base station or another UE). In some aspects, the UE may receive the configuration information via RRC signaling and/or MAC signaling (e.g., MAC CEs). In some aspects, the configuration information may include an indication of one or more configuration parameters (e.g., already known to the UE) for selection by the UE and/or explicit configuration information for the UE to use to configure the UE.

In some aspects, the configuration information may indicate that the UE is to transmit and/or receive control information using guard intervals, as described herein. For example, the configuration information may indicate one or more guard interval characteristics and one or more values mapped to each of the one or more guard interval characteristics. For example, different guard interval characteristics (e.g., guard interval sequence parameters, length, type, spatial domain indices, time domain indices, and/or the like) or combinations of guard interval characteristics may be mapped to bit values (e.g., 0s and 1s). In some aspects, different guard interval characteristics and combinations of guard interval characteristics, and/or different bit values, may be mapped to different types of control information, as described herein. In some aspects, the configuration information may indicate a period of time between one of the guard intervals and application of the control information by the UE. As described herein, based on the configuration information, the UE may transmit/receive control information using the mapping of guard interval characteristics, as described herein.

As shown by reference number 510, the UE may configure the UE for communicating with the base station. In some aspects, the UE may configure the UE based at least in part on the configuration information. In some aspects, the UE may be configured to perform one or more operations described herein.

As shown by reference number 515, the base station may map control information, for the UE, to one or more guard interval characteristics of one or more guard intervals. In some aspects, control information may include one or more of: a beam change indicator (e.g., transmission configuration indicator (TCI) update), MCS change, indication of buffer control value (e.g., k0), DCI data (e.g., a portion of DCI, which may include all of second stage DCI), feedback data for hybrid automatic repeat request (HARD), CSI feedback, a waveform indicator (e.g., SC-FDE indicator, DFT-s indicator, and/or the like), SC frequency shaping filter coefficients, and/or the like.

In some aspects, the one or more guard interval characteristics may include one or more sequence parameters of the one or more guard intervals (e.g., cyclic shifts of a guard interval sequence, roots of a guard interval sequence, and/or the like), one or more lengths of the one or more guard intervals (e.g., the base station and/or UE may be configured to transmit and/or receive guard intervals of different lengths), one or more types of the one or more guard intervals (e.g., a zero-tail guard interval, unique word guard interval, and/or the like), spatial domain indices of the one or more guard intervals (e.g., port indices of the port(s) at which the guard interval(s) are transmitted and/or received), time domain indices of the one or more guard intervals (e.g., indices of particular guard intervals within a predetermined window of multiple guard intervals), and/or the like.

In some aspects, one or more bits of the control information may be mapped to one or more guard interval characteristics. The mapping may be two-way, such that the one or more bits are mapped to (and indicate, or correspond to) the one or more guard interval characteristics, and the one or more guard interval characteristics are mapped to (and indicate, or correspond to) the one or more bits. For example, different guard interval characteristics may correspond to different bit values (e.g., 0s and 1s) that may be used to convey control information. By way of example, different sequence parameters may be associated with different bit values, such that in a situation where four cyclic shifts are used, a first cyclic shift may be associated with the bit value 00, a second cyclic shift may be associated with the bit value 01, a third cyclic shift value may be associated with the bit value 10, and a fourth cyclic shift value may be associated with the bit value 11. In a situation where two different guard interval lengths are configured, a first guard interval length may be associated with a 0, while a second guard interval length may be associated with a 1. One type of guard interval (e.g., zero-tail) may be associated with a 0, while another type of guard interval (e.g., unique word) may be associated with a 1. One port via which the guard interval was transmitted and/or received may be associated with a 0, while another port may be associated with a 1. In a situation where time domain indices are used, guard intervals with different guard interval characteristics may indicate a change between a 0 and a 1. For example, in a time window that includes 4 guard intervals, the first, second, and fourth guard intervals may share a particular guard interval characteristic (e.g., all have a first guard interval length), while the third guard interval has a different guard interval characteristic (e.g., a second guard interval length). In this situation, the time window may indicate a bit value of 0010 (or, if configured differently, 1101).

In some aspects, the base station may map control information to two sets of guard intervals, such that each guard interval of the first set has a first set of guard interval characteristics and each guard interval of the second set has a second set of guard interval characteristics. In this situation, the first set of guard interval characteristics may indicate (e.g., be mapped to) a first value of the control information, and the second set of guard interval characteristics may indicate a second value of the control information. For example, each guard interval in a first set of guard intervals may be transmitted in a first time window and may be associated with the same guard interval characteristics, indicating a first value (e.g., 0), and each guard interval in a second set of guard intervals may be transmitted in a second time window and may be associated with the same guard interval characteristics (different from the guard interval characteristics of the first set), indicating a second value (e.g., 1). In other words, across multiple windows of time, where time each window includes guard intervals with characteristics that match within the time window, one bit of information may be indicated in each time window.

In some aspects, bits of control information may be mapped to different combinations of guard interval characteristics. For example, a first guard interval having a first length and a first guard interval type may be mapped to the bit value 00, a second guard interval having the first length and a second guard interval type may be mapped to the bit value 01, a third guard interval having a second length and the first guard interval type may be mapped to the bit value 10, and a fourth guard interval having the second length and the second guard interval type may be mapped to the bit value 11. Other combinations of guard interval characteristics may be used to indicate other bit values and may be extended in the time domain to further increase the number of bits being indicated.

In some aspects, different types of control information may be mapped to different guard interval characteristics or combinations of guard interval characteristics. For example, the configuration information may include information mapping the different guard interval characteristics, or combinations of guard interval characteristics, to different types of control information. By way of example, a cyclic shift (e.g., one of the guard interval sequence parameters) may be mapped to one or more bits that are to be used to indicate an MCS change; guard interval types may be mapped to a bit used to indicate HARQ feedback, and a combination of guard interval lengths and time domain indices may be mapped to bits used to indicate SC frequency shaping filter coefficients. As another example, spatial domain indices (e.g., indicating the port at which the wireless communication including the guard interval(s) is received) may be used, such that guard intervals communicated via a first port may be associated with one type of control information, while guard intervals communicated via another port may be associated with another type of control information. Similarly, time domain indices may be used, such that guard intervals communicated at different periods of time (e.g., as previously configured by the configuration information) may be associated with different types of control information.

In some aspects, the base station may apply a channel coding technique or an error detection technique to the control information. For example, the base station may apply one or more channel coding techniques, such as polar codes, convolutional codes, block codes, repetition code (e.g., with a simple majority decision), and/or the like. The error detection techniques(s) applied may include a cyclic redundancy check (CRC), parity bits, and/or the like, which may be added to control information for error detection. Using channel coding and/or error detection may improve, for example, the reliability of reception of the control information.

In some aspects, the wireless communication may include a DMRS (e.g., to enable channel estimation by the UE). In this situation, the one or more guard intervals may include a first set of guard intervals with a first set of guard interval characteristics and a second guard interval (or set of guard intervals) with a second set of guard interval characteristics. The second guard interval may correspond to the DMRS. For example, when communicating a DMRS, the guard interval should be known by the transmitter and recipient, and different guard intervals may be used at different symbols of the wireless communication to provide the DMRS with an expected guard interval. In some aspects, the time window for transmitting and/or receiving the DMRS may be delayed and/or shortened to enable the second guard interval (e.g., the DMRS guard interval) to be used for one or more symbols and enable switching back to the first guard interval for communicating configuration information. In some aspects, without using a separate known guard interval for the DMRS, the UE may estimate the channel using multiple guard interval hypotheses on the DMRS symbol.

As shown by reference number 520, the base station may transmit, and the UE may receive, a wireless communication. The wireless communication may include the one or more guard intervals. For example, the wireless communication may extend across multiple symbols, slots, subframes, frames, and/or the like, and the guard intervals that indicate control information may be included in the wireless communication (e.g., in consecutive and/or non-consecutive symbols, slots, subframes, frames, and/or the like).

In some aspects, the wireless communication may not be associated with a corresponding communication channel (e.g., PDCCH, PDSCH, and/or the like on the downlink, and PUCCH, PUSCH, and/or the like on the uplink). For example, to communicate control information, there need not be other data to be communicated via other channels.

In some aspects, a portion of the wireless communication may be transmitted to another wireless device. For example, the wireless communication may include a PDSCH for one UE, but the wireless communication may include guard intervals that a different UE may use to receive control information.

As shown by reference number 525, the UE may identify, based on one or more guard interval characteristics of the one or more guard intervals, control information for the UE. For example, the guard interval characteristics may be mapped to one or more bits that represent the control information, as described herein. In some aspects, the UE may apply a channel coding technique and/or an error detection technique to improve the reception reliability of the control information. The mapping of guard interval characteristics to control information may be performed as described herein. For example, the UE receiving the control information may perform opposite steps as those performed by the base station. In other words, while the base station may map control information to guard interval characteristics, the UE may map the guard interval characteristics back to the control information. As described herein, the mapping may be bi-directional, enabling mapping of control information to guard interval characteristics and guard interval characteristics to control information.

While FIG. 5 depicts the base station as the transmitter of control information and the UE as the receiver of the control information. In some aspects, the UE may perform one or more steps similar to those performed by the base station (e.g., steps similar to those described herein with reference to reference numbers 515 and 520) to transmit control information to the base station via uplink or to another UE via sidelink. For example, the UE may map at least a portion of UCI to one or more guard intervals of a wireless communication to the base station. Example UCI may include a HARQ identifier, new data indicator (NDI), redundancy version (RV), channel occupancy time (COT) sharing information, and/or the like.

As indicated above, FIG. 5 is provided as an example. Other examples may differ from what is described with regard to FIG. 5. For example, while example 500 is described as being used to communicate control information, other forms of data may be communicated that might not be considered control information. For example, any information capable of being represented by bit vales may be transmitted using guard interval characteristics, as described herein.

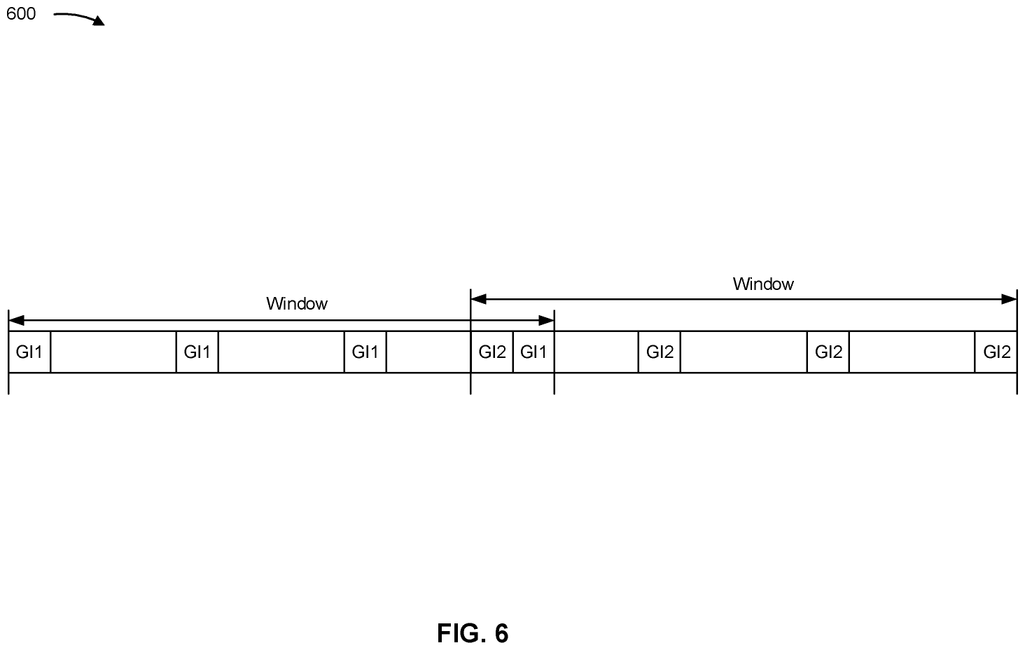

FIG. 6 is a diagram illustrating an example 600 associated with guard interval communications using time domain indices, in accordance with the present disclosure. As shown in FIG. 6, a communication may span two windows of time (e.g., depicted as spanning 4 symbols each), where the first time window includes a first guard interval (G1) associated with a first set of guard interval characteristics, and the second time window includes a second guard interval (G2) associated with a second set of guard interval characteristics. In this example, the first time window may represent a bit value of 0, while the second time window may represent a bit value of 1. The representation of the bit values may be based on configuration information indicating that time windows including the first type of guard interval (G1) are mapped to the value 0 and that time windows including the second type of guard interval (G2) are mapped to the value 1. In some aspects, more time windows may be included to enable signaling of additional bits (e.g., 4 time windows would enable 4 bits of information to be indicated), and different time window sizes may also be used (e.g., depending on the configuration).

As indicated above, FIG. 6 is provided as an example. Other examples may differ from what is described with respect to FIG. 6.

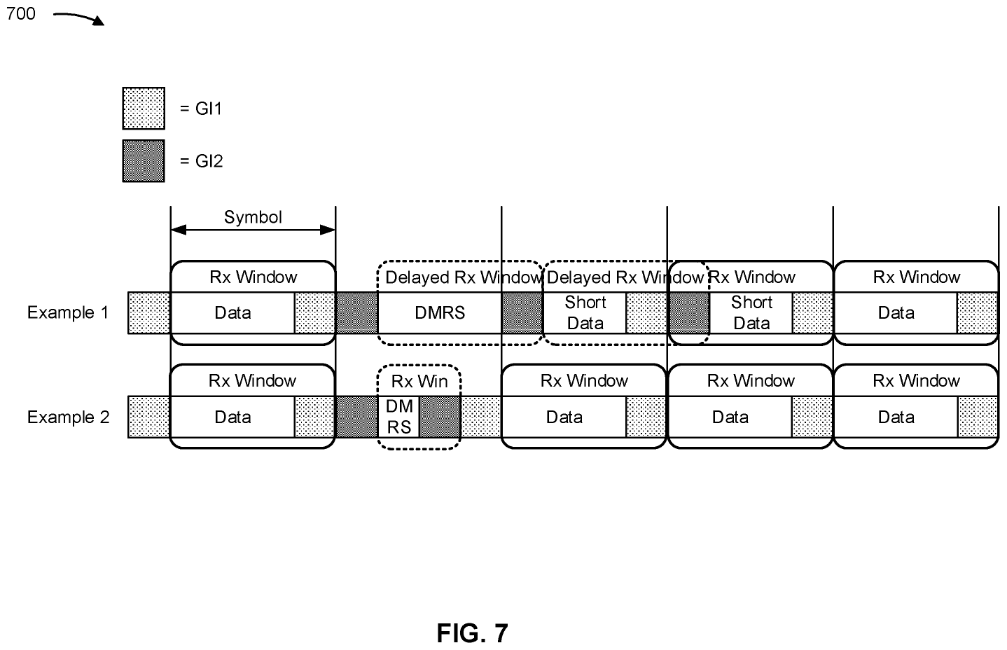

FIG. 7 is a diagram illustrating an example 700 associated with guard interval communications including DMRS, in accordance with the present disclosure. As shown in FIG. 7, when communicating control information via a first set of guard intervals (e.g., G1), DMRS may be associated with a separate guard interval (e.g., GI2). In the first example, the reception (Rx) window for the DMRS may be delayed to enable insertion of GI2 for the DMRS in the second symbol, and the first type of guard interval may be reinserted after transmission of the DMRS. In the second example, the DMRS is associated with a shorter Rx window that enables the GI2 to be inserted entirely within the second symbol, which also enables re-insertion of GI1 at the end of the second symbol to further using GI1 for communication of control information. This enables communication of the DMRS, which uses a specific guard interval, while still enabling guard intervals to be used for the communication of control information, as described herein.

As indicated above, FIG. 7 is provided as an example. Other examples may differ from what is described with respect to FIG. 7.

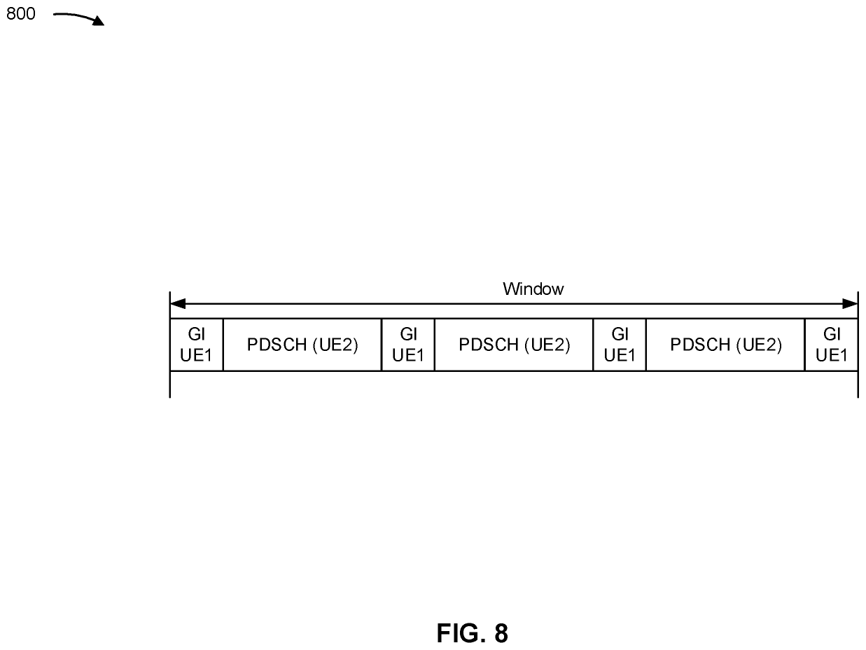

FIG. 8 is a diagram illustrating an example 800 associated with guard interval communications on a communication to different devices, in accordance with the present disclosure. As shown in FIG. 8, a PDSCH may be transmitted to a UE (e.g., UE2). The symbol including the PDSCH may also include a guard interval (e.g., GI UE1) that is used to communicate control information to a different UE (e.g., UE1). The recipient of the PDSCH (e.g., UE2) may use the guard interval when receiving the PDSCH without obtaining control information from the guard interval. The other device (e.g., UE1) may ignore the PDSCH while using the guard intervals to obtain control information. In some aspects, a similar method may be used to enable transmission of control information to multiple devices, such as in a situation where multiple UEs would receive the communication and obtain control information from the guard interval characteristics of the communication, as described herein.

As indicated above, FIG. 8 is provided as an example. Other examples may differ from what is described with respect to FIG. 8.

FIG. 9 is a diagram illustrating an example process 900 performed, for example, by a UE, in accordance with the present disclosure. Example process 900 is an example where the UE (e.g., UE 120) performs operations associated with guard interval communications.

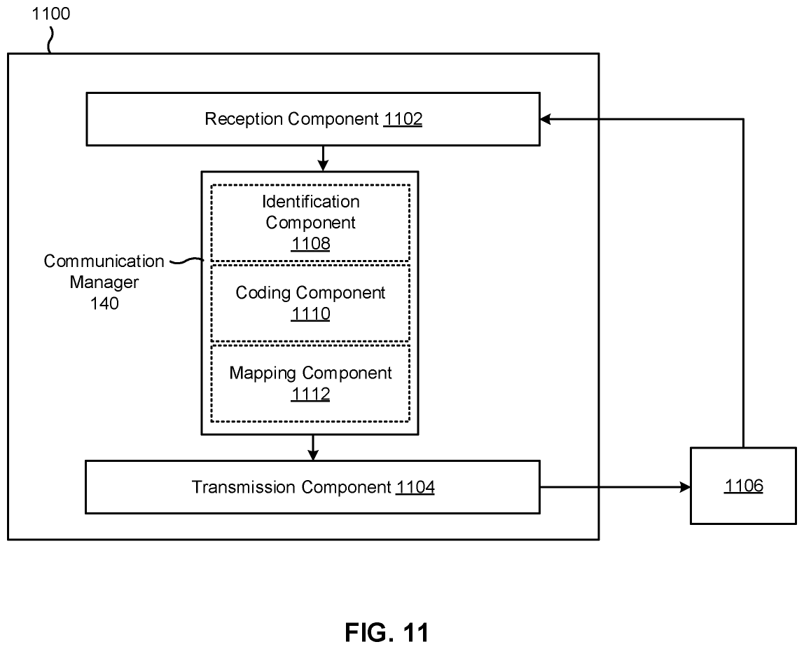

As shown in FIG. 9, in some aspects, process 900 may include receiving, from a base station, a wireless communication, the wireless communication including one or more guard intervals (block 910). For example, the UE (e.g., using communication manager 140 and/or reception component 1102, depicted in FIG. 11) may receive, from a base station, a wireless communication, the wireless communication including one or more guard intervals, as described above.

As further shown in FIG. 9, in some aspects, process 900 may include identifying, based on one or more guard interval characteristics of the one or more guard intervals, control information for the UE (block 920). For example, the UE (e.g., using communication manager 140 and/or identification component 1108, depicted in FIG. 11) may identify, based on one or more guard interval characteristics of the one or more guard intervals, control information for the UE, as described above.

Process 900 may include additional aspects, such as any single aspect or any combination of aspects described below and/or in connection with one or more other processes described elsewhere herein.

In a first aspect, process 900 includes receiving, from the base station, configuration information indicating the one or more guard interval characteristics and one or more values mapped to each of the one or more guard interval characteristics.

In a second aspect, alone or in combination with the first aspect, the configuration information further indicates a period of time between one of the one or more guard intervals and application of the control information by the UE.

In a third aspect, alone or in combination with one or more of the first and second aspects, the one or more guard interval characteristics are mapped to one or more bits of the control information.

In a fourth aspect, alone or in combination with one or more of the first through third aspects, the one or more guard interval characteristics include at least one of one or more sequence parameters of the one or more guard intervals, one or more lengths of the one or more guard intervals, one or more types of the one or more guard intervals, spatial domain indices of the one or more guard intervals, or time domain indices of the one or more guard intervals.

In a fifth aspect, alone or in combination with one or more of the first through fourth aspects, the wireless communication is not associated with a PDSCH or PDCCH.

In a sixth aspect, alone or in combination with one or more of the first through fifth aspects, the one or more guard intervals comprises a first set of guard intervals and a second set of guard intervals, wherein each of the first set of guard intervals has a first set of guard interval characteristics, wherein each of the second set of guard intervals has a second set of guard interval characteristics, wherein the first set of guard interval characteristics indicates a first value of the control information, and wherein the second set of guard interval characteristics indicates a second value of the control information.

In a seventh aspect, alone or in combination with one or more of the first through sixth aspects, process 900 includes applying at least one of a channel coding technique or an error detection technique to the control information.

In an eighth aspect, alone or in combination with one or more of the first through seventh aspects, the wireless communication includes a DMRS, wherein the one or more guard intervals comprises a first set of guard intervals with a first set of guard interval characteristics and a second guard interval with a second set of guard interval characteristics, and wherein the second guard interval corresponds to the DMRS.

In a ninth aspect, alone or in combination with one or more of the first through eighth aspects, a portion of the wireless communication is transmitted to another wireless device.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a base station, in accordance with the present disclosure. Example process 1000 is an example where the base station (e.g., base station 110) performs operations associated with guard interval communications.

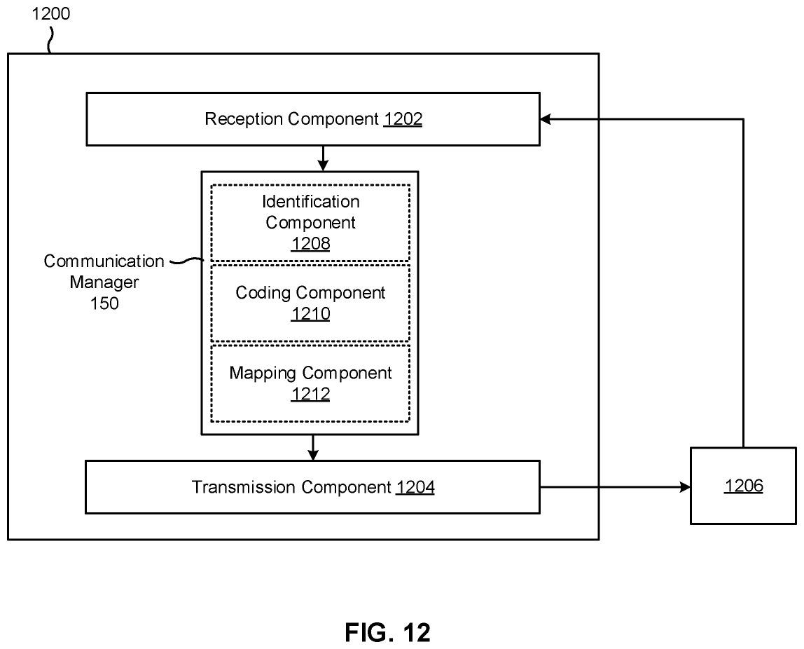

As shown in FIG. 10, in some aspects, process 1000 may include mapping control information, for a UE, to one or more guard interval characteristics of one or more guard intervals (block 1010). For example, the base station (e.g., using communication manager 150 and/or mapping component 1212, depicted in FIG. 12) may map control information, for a UE, to one or more guard interval characteristics of one or more guard intervals, as described above.

As further shown in FIG. 10, in some aspects, process 1000 may include transmitting, to the UE, a wireless communication, the wireless communication including the one or more guard intervals (block 1020). For example, the base station (e.g., using communication manager 150 and/or transmission component 1204, depicted in FIG. 12) may transmit, to the UE, a wireless communication, the wireless communication including the one or more guard intervals, as described above.

Process 1000 may include additional aspects, such as any single aspect or any combination of aspects described below and/or in connection with one or more other processes described elsewhere herein.

In a first aspect, process 1000 includes transmitting, to the UE, configuration information indicating the one or more guard interval characteristics and one or more values mapped to each of the one or more guard interval characteristics.

In a second aspect, alone or in combination with the first aspect, the configuration information further indicates a period of time between one of the one or more guard intervals and application of the control information by the UE.

In a third aspect, alone or in combination with one or more of the first and second aspects, each of the one or more guard interval characteristics correspond to one or more bits of the control information.

In a fourth aspect, alone or in combination with one or more of the first through third aspects, the one or more guard interval characteristics include at least one of one or more sequence parameters of the one or more guard intervals, one or more lengths of the one or more guard intervals, one or more types of the one or more guard intervals, spatial domain indices of the one or more guard intervals, or time domain indices of the one or more guard intervals.

In a fifth aspect, alone or in combination with one or more of the first through fourth aspects, the wireless communication is not associated with a PDSCH or PDCCH.

In a sixth aspect, alone or in combination with one or more of the first through fifth aspects, the one or more guard intervals comprises a first set of guard intervals and a second set of guard intervals, wherein each of the first set of guard intervals has a first set of guard interval characteristics, wherein each of the second set of guard intervals has a second set of guard interval characteristics, wherein the first set of guard interval characteristics indicates a first value of the control information, and wherein the second set of guard interval characteristics indicates a second value of the control information.

In a seventh aspect, alone or in combination with one or more of the first through sixth aspects, process 1000 includes applying at least one of a channel coding technique or an error detection technique to the control information.

In an eighth aspect, alone or in combination with one or more of the first through seventh aspects, the wireless communication includes a DMRS, wherein the one or more guard intervals comprises a first set of guard intervals with a first set of guard interval characteristics and a second guard interval with a second set of guard interval characteristics, and wherein the second guard interval corresponds to the DMRS.

In a ninth aspect, alone or in combination with one or more of the first through eighth aspects, a portion of the wireless communication is transmitted to a wireless device separate from the UE.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

In this way, some techniques and apparatuses described herein enable wireless devices to communicate information (e.g., control information) using guard intervals. For example, a first wireless device may transmit a wireless communication to a second wireless device, and the wireless communication may include one or more guard intervals. Upon receipt of the wireless communication, the second wireless device may identify, based on one or more characteristics of the guard interval(s), control information. For example, guard interval characteristics may be mapped to bit values that represent the control information. As a result, wireless devices may communicate control information to one another using less power and network resources than would be used to communicate control information via RRC, MAC-CE, DCI, UCI, and/or the like. Reduced usage of power and network resources may enable wireless devices to conserve power, reduce network congestion, and improve network performance, among other examples.

FIG. 11 is a diagram of an example apparatus 1100 for wireless communication. The apparatus 1100 may be a UE, or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 140. The communication manager 140 may include one or more of a identification component 1108, a coding component 1110, or a mapping component 1112, among other examples.

In some aspects, the apparatus 1100 may be configured to perform one or more operations described herein in connection with FIGS. 3-8. Additionally, or alternatively, the apparatus 1100 may be configured to perform one or more processes described herein, such as process 900 of FIG. 9, process 1000 of FIG. 10, or a combination thereof. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The reception component 1102 may receive, from a base station, a wireless communication, the wireless communication including one or more guard intervals. The identification component 1108 may identify, based on one or more guard interval characteristics of the one or more guard intervals, control information for the UE.

The reception component 1102 may receive, from the base station, configuration information indicating the one or more guard interval characteristics and one or more values mapped to each of the one or more guard interval characteristics.

The coding component 1110 may apply at least one of a channel coding technique or an error detection technique to the control information.

The mapping component 1112 may map control information, for a base station, to one or more guard interval characteristics of one or more guard intervals. The transmission component 1104 may transmit, to the base station, a wireless communication, the wireless communication including the one or more guard intervals.

The transmission component 1104 may transmit, to the base station, configuration information indicating the one or more guard interval characteristics and one or more values mapped to each of the one or more guard interval characteristics.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication. The apparatus 1200 may be a base station, or a base station may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 150. The communication manager 150 may include one or more of a identification component 1208, a coding component 1210, or a mapping component 1212, among other examples.

In some aspects, the apparatus 1200 may be configured to perform one or more operations described herein in connection with FIGS. 3-8. Additionally, or alternatively, the apparatus 1200 may be configured to perform one or more processes described herein, such as process 900 of FIG. 9, process 1000 of FIG. 10, or a combination thereof. In some aspects, the apparatus 1200 and/or one or more components shown in FIG. 12 may include one or more components of the base station described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the base station described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the base station described in connection with FIG. 2. In some aspects, the transmission component 1204 may be co-located with the reception component 1202 in a transceiver.

The reception component 1202 may receive, from a UE, a wireless communication, the wireless communication including one or more guard intervals. The identification component 1208 may identify, based on one or more guard interval characteristics of the one or more guard intervals, control information for the base station.

The reception component 1202 may receive, from the UE, configuration information indicating the one or more guard interval characteristics and one or more values mapped to each of the one or more guard interval characteristics.

The coding component 1210 may apply at least one of a channel coding technique or an error detection technique to the control information.

The mapping component 1212 may map control information, for a UE, to one or more guard interval characteristics of one or more guard intervals. The transmission component 1204 may transmit, to the UE, a wireless communication, the wireless communication including the one or more guard intervals.

The transmission component 1204 may transmit, to the UE, configuration information indicating the one or more guard interval characteristics and one or more values mapped to each of the one or more guard interval characteristics.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a UE, comprising: receiving, from a base station, a wireless communication, the wireless communication including one or more guard intervals; and identifying, based on one or more guard interval characteristics of the one or more guard intervals, control information for the UE.

Aspect 2: The method of Aspect 1, further comprising: receiving, from the base station, configuration information indicating the one or more guard interval characteristics and one or more values mapped to each of the one or more guard interval characteristics.

Aspect 3: The method of Aspect 2, wherein the configuration information further indicates a period of time between one of the one or more guard intervals and application of the control information by the UE.

Aspect 4: The method of any of Aspects 1-3, wherein the one or more guard interval characteristics are mapped to one or more bits of the control information.

Aspect 5: The method of any of Aspects 1-4, wherein the one or more guard interval characteristics include at least one of: one or more sequence parameters of the one or more guard intervals, one or more lengths of the one or more guard intervals, one or more types of the one or more guard intervals, spatial domain indices of the one or more guard intervals, or time domain indices of the one or more guard intervals.

Aspect 6: The method of any of Aspects 1-5, wherein the wireless communication is not associated with a PDSCH or PDCCH.

Aspect 7: The method of any of Aspects 1-6, wherein the one or more guard intervals comprises a first set of guard intervals and a second set of guard intervals, wherein each of the first set of guard intervals has a first set of guard interval characteristics, wherein each of the second set of guard intervals has a second set of guard interval characteristics, wherein the first set of guard interval characteristics indicates a first value of the control information, and wherein the second set of guard interval characteristics indicates a second value of the control information.

Aspect 8: The method of any of Aspects 1-7, further comprising: applying at least one of a channel coding technique or an error detection technique to the control information.

Aspect 9: The method of any of Aspects 1-8, wherein the wireless communication includes a DMRS, wherein the one or more guard intervals comprises a first set of guard intervals with a first set of guard interval characteristics and a second guard interval with a second set of guard interval characteristics, and wherein the second guard interval corresponds to the DMRS.

Aspect 10: The method of any of Aspects 1-9, wherein a portion of the wireless communication is transmitted to another wireless device.

Aspect 11: A method of wireless communication performed by a base station, comprising: mapping control information, for a UE, to one or more guard interval characteristics of one or more guard intervals; and transmitting, to the UE, a wireless communication, the wireless communication including the one or more guard intervals.

Aspect 12: The method of Aspect 11, further comprising: transmitting, to the UE, configuration information indicating the one or more guard interval characteristics and one or more values mapped to each of the one or more guard interval characteristics.

Aspect 13: The method of Aspect 12, wherein the configuration information further indicates a period of time between one of the one or more guard intervals and application of the control information by the UE.

Aspect 14: The method of any of Aspects 11-13, wherein each of the one or more guard interval characteristics correspond to one or more bits of the control information.

Aspect 15: The method of any of Aspects 11-14, wherein the one or more guard interval characteristics include at least one of: one or more sequence parameters of the one or more guard intervals, one or more lengths of the one or more guard intervals, one or more types of the one or more guard intervals, spatial domain indices of the one or more guard intervals, or time domain indices of the one or more guard intervals.

Aspect 16: The method of any of Aspects 11-15, wherein the wireless communication is not associated with a PDSCH or PDCCH.

Aspect 17: The method of any of Aspects 11-16, wherein the one or more guard intervals comprises a first set of guard intervals and a second set of guard intervals, wherein each of the first set of guard intervals has a first set of guard interval characteristics, wherein each of the second set of guard intervals has a second set of guard interval characteristics, wherein the first set of guard interval characteristics indicates a first value of the control information, and wherein the second set of guard interval characteristics indicates a second value of the control information.

Aspect 18: The method of any of Aspects 11-17, further comprising: applying at least one of a channel coding technique or an error detection technique to the control information.

Aspect 19: The method of any of Aspects 11-18, wherein the wireless communication includes a DMRS, wherein the one or more guard intervals comprises a first set of guard intervals with a first set of guard interval characteristics and a second guard interval with a second set of guard interval characteristics, and wherein the second guard interval corresponds to the DMRS.

Aspect 20: The method of any of Aspects 11-19, wherein a portion of the wireless communication is transmitted to a wireless device separate from the UE.

Aspect 21: An apparatus for wireless communication at a device, comprising a processor; memory coupled with the processor; and instructions stored in the memory and executable by the processor to cause the apparatus to perform the method of one or more of Aspects 1-10.

Aspect 22: An apparatus for wireless communication at a device, comprising a processor; memory coupled with the processor; and instructions stored in the memory and executable by the processor to cause the apparatus to perform the method of one or more of Aspects 11-20.

Aspect 23: A device for wireless communication, comprising a memory and one or more processors coupled to the memory, the one or more processors configured to perform the method of one or more of Aspects 1-10.

Aspect 24: A device for wireless communication, comprising a memory and one or more processors coupled to the memory, the one or more processors configured to perform the method of one or more of Aspects 11-20.

Aspect 25: An apparatus for wireless communication, comprising at least one means for performing the method of one or more of Aspects 1-10.

Aspect 26: An apparatus for wireless communication, comprising at least one means for performing the method of one or more of Aspects 11-20.

Aspect 27: A non-transitory computer-readable medium storing code for wireless communication, the code comprising instructions executable by a processor to perform the method of one or more of Aspects 1-10.

Aspect 28: A non-transitory computer-readable medium storing code for wireless communication, the code comprising instructions executable by a processor to perform the method of one or more of Aspects 11-20.

Aspect 29: A non-transitory computer-readable medium storing a set of instructions for wireless communication, the set of instructions comprising one or more instructions that, when executed by one or more processors of a device, cause the device to perform the method of one or more of Aspects 1-10.

Aspect 30: A non-transitory computer-readable medium storing a set of instructions for wireless communication, the set of instructions comprising one or more instructions that, when executed by one or more processors of a device, cause the device to perform the method of one or more of Aspects 11-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive, from a base station, a wireless communication, the wireless communication including one or more guard intervals; and
identify, based on one or more guard interval characteristics of the one or more guard intervals, control information for the UE.

2. The UE of claim 1, wherein the one or more processors are further configured to:
receive, from the base station, configuration information indicating the one or more guard interval characteristics and one or more values mapped to each of the one or more guard interval characteristics.

3. The UE of claim 2, wherein the configuration information further indicates a period of time between one of the one or more guard intervals and application of the control information by the UE.

4. The UE of claim 1, wherein the one or more guard interval characteristics are mapped to one or more bits of the control information.

5. The UE of claim 1, wherein the one or more guard interval characteristics include at least one of:
one or more sequence parameters of the one or more guard intervals,
one or more lengths of the one or more guard intervals,
one or more types of the one or more guard intervals,
spatial domain indices of the one or more guard intervals, or
time domain indices of the one or more guard intervals.

6. The UE of claim 1, wherein the wireless communication is not associated with a physical downlink shared channel (PDSCH) or physical downlink control channel (PDCCH).

7. The UE of claim 1, wherein the one or more guard intervals comprises a first set of guard intervals and a second set of guard intervals,
wherein each of the first set of guard intervals has a first set of guard interval characteristics,
wherein each of the second set of guard intervals has a second set of guard interval characteristics,
wherein the first set of guard interval characteristics indicates a first value of the control information, and
wherein the second set of guard interval characteristics indicates a second value of the control information.

8. The UE of claim 1, wherein the one or more processors are further configured to:
apply at least one of a channel coding technique or an error detection technique to the control information.

9. The UE of claim 1, wherein the wireless communication includes a demodulation reference signal (DMRS),
wherein the one or more guard intervals comprises a first set of guard intervals with a first set of guard interval characteristics and a second guard interval with a second set of guard interval characteristics, and
wherein the second guard interval corresponds to the DMRS.

10. The UE of claim 1, wherein a portion of the wireless communication is transmitted to another wireless device.

11. A base station for wireless communication, comprising:
a memory; and
one or more processors, coupled to the memory, configured to:
map control information, for a user equipment (UE), to one or more guard interval characteristics of one or more guard intervals; and
transmit, to the UE, a wireless communication, the wireless communication including the one or more guard intervals.

12. The base station of claim 11, wherein the one or more processors are further configured to:
transmit, to the UE, configuration information indicating the one or more guard interval characteristics and one or more values mapped to each of the one or more guard interval characteristics.

13. The base station of claim 12, wherein the configuration information further indicates a period of time between one of the one or more guard intervals and application of the control information by the UE.

14. The base station of claim 11, wherein each of the one or more guard interval characteristics correspond to one or more bits of the control information.

15. The base station of claim 11, wherein the one or more guard interval characteristics include at least one of:
one or more sequence parameters of the one or more guard intervals,
one or more lengths of the one or more guard intervals,
one or more types of the one or more guard intervals,
spatial domain indices of the one or more guard intervals, or
time domain indices of the one or more guard intervals.

16. The base station of claim 11, wherein the wireless communication is not associated with a physical downlink shared channel (PDSCH) or physical downlink control channel (PDCCH).

17. The base station of claim 11, wherein the one or more guard intervals comprises a first set of guard intervals and a second set of guard intervals,
wherein each of the first set of guard intervals has a first set of guard interval characteristics,
wherein each of the second set of guard intervals has a second set of guard interval characteristics,
wherein the first set of guard interval characteristics indicates a first value of the control information, and
wherein the second set of guard interval characteristics indicates a second value of the control information.

18. The base station of claim 11, wherein the one or more processors are further configured to:
apply at least one of a channel coding technique or an error detection technique to the control information.

19. The base station of claim 11, wherein the wireless communication includes a demodulation reference signal (DMRS),
wherein the one or more guard intervals comprises a first set of guard intervals with a first set of guard interval characteristics and a second guard interval with a second set of guard interval characteristics, and
wherein the second guard interval corresponds to the DMRS.

20. The base station of claim 11, wherein a portion of the wireless communication is transmitted to a wireless device separate from the UE.

21. A method of wireless communication performed by a user equipment (UE), comprising:
receiving, from a base station, a wireless communication, the wireless communication including one or more guard intervals; and
identifying, based on one or more guard interval characteristics of the one or more guard intervals, control information for the UE.

22. The method of claim 21, further comprising:
receiving, from the base station, configuration information indicating the one or more guard interval characteristics and one or more values mapped to each of the one or more guard interval characteristics.

23. The method of claim 22, wherein the configuration information further indicates a period of time between one of the one or more guard intervals and application of the control information by the UE.

24. The method of claim 21, wherein the one or more guard interval characteristics are mapped to one or more bits of the control information.

25. The method of claim 21, wherein the one or more guard interval characteristics include at least one of:
one or more sequence parameters of the one or more guard intervals,
one or more lengths of the one or more guard intervals,
one or more types of the one or more guard intervals,
spatial domain indices of the one or more guard intervals, or
time domain indices of the one or more guard intervals.

26. A method of wireless communication performed by a base station, comprising:
mapping control information, for a user equipment (UE), to one or more guard interval characteristics of one or more guard intervals; and
transmitting, to the UE, a wireless communication, the wireless communication including the one or more guard intervals.

27. The method of claim 26, further comprising:
transmitting, to the UE, configuration information indicating the one or more guard interval characteristics and one or more values mapped to each of the one or more guard interval characteristics.

28. The method of claim 27, wherein the configuration information further indicates a period of time between one of the one or more guard intervals and application of the control information by the UE.

29. The method of claim 26, wherein each of the one or more guard interval characteristics correspond to one or more bits of the control information.

30. The method of claim 26, wherein the one or more guard interval characteristics include at least one of:
one or more sequence parameters of the one or more guard intervals,
one or more lengths of the one or more guard intervals,
one or more types of the one or more guard intervals,
spatial domain indices of the one or more guard intervals, or
time domain indices of the one or more guard intervals.
